(19) United States
(12) Patent Application Publication
(10) Pub. No.: US 2019/0114685 A1
(43) Pub. Date: Apr. 18, 2019

(54) SYSTEM AND METHOD FOR AUTOMATED DISPENSING OF CONTROLLED SUBSTANCES

(71) Applicant: Richard Postrel, Miami Beach, FL (US)

(72) Inventor: Richard Postrel, Miami Beach, FL (US)

(21) Appl. No.: 15/783,045

(22) Filed: Oct. 13, 2017

(51) Int. Cl. G06Q 30/06; G07F 17/00; G06F 21/32; G07F 11/00; G06Q 20/20; G06F 19/00

(52) U.S. Cl. CPC G06Q 30/0607; G07F 17/0014; G06F 19/3462; G07F 11/002; G06Q 20/206; G06F 21/32

(57) ABSTRACT

A method and system for dispensing a product having a controlled substance. A dispensing system receives a request input to obtain the product from the dispensing system. The dispensing system reads an identification card encoded with user identification. A biometric data input device obtains biometric data from the user, and then a user verification process is executed using the user identification and the obtained biometric data. If the user verification process fails, then the user is informed that access to the product is denied. If, however, the user verification process passes, a product accessibility determination is executed. If the product accessibility determination fails, then the user is informed that access to the product is denied. If, however, the product accessibility determination passes, then a measurement process is executed and a payment process is executed to obtain payment for the measured product, and the product is dispensed to the user.

### BACKGROUND

Controlled substances are increasingly being made legal and may be sold over the counter in some jurisdictions. The demand for sales of such product is high, resulting in long lines for purchasing the product and high expenses for employing trained workers to legally and properly dispense the controlled substance. There is also a potential for mistakes, or for fraud and abuses of the system when humans are used to sell the controlled substance. It is therefore desired to provide an automated dispensing system to securely and accurately dispense measured quantities of controlled substances (including prescription medications) only to authorized users in authorized amounts and only under certain guidelines and restrictions that may be imposed by various authorities.

### SUMMARY

Provided herein is a method and system for automatically dispensing a product containing a controlled substance such as but not limited to opioids, marijuana or any type of prescription medication, for both recreational and medical use. This dispensing system may be in the form of an autonomous pharmacy—a fully automated or integrated dispensing, tracking, compliance and payment system; or it may take the form of a stand-alone automated dispensing machine (similar to a vending machine) that provides the same functionality in a self-contained and stand-alone environment. The dispensing system may also utilize live or virtual professional or licensed personnel for customer assistance to operate in a semi-automated manner. This centralized system will reduce cost, improve customer experience, shorten service wait time, an increase up-selling and cross selling at the point of sale, while reducing theft, fraud and breakage as well as product liability. The system also self-generates all notifications—both jurisdictional and customer direct—and manages customer privacy and data protection with an additional higher level of security. This invention helps to reduce abuses of the drug distribution system and can eliminate prescription-shopping. The system helps to identify offending users and enablers by providing a central management system that approves of and records the utilization of these controlled substances.

One exemplary aspect of the invention is a method and system for automatically dispensing a product that has a controlled substance. This may be accomplished by using one or more automated dispensing systems that may be placed in essentially any location, such as at a pharmacy. In one embodiment, the method implemented with the automated dispensing system provides that the dispensing system receives a request input from a user to obtain from the dispensing system a certain quantity of a product comprising a controlled substance. The automated dispensing system receives and reads an identification card presented by the user, the identification card being encoded with a user identification. The dispensing system utilizes a biometric data input device to obtain biometric data (which may include retinal scan data, fingerprint data, and/or vocal scan data) from the user, and then executes a user verification process using the user identification and the biometric data obtained from the user. If the user verification process fails, then the user is informed that access to the product is denied and the failed attempt is logged into memory. If, however, the user verification process passes, then a product accessibility determination is executed to see if the user can purchase the requested product and in what quantity. If the product accessibility determination fails, then the user is informed that access to the product is denied and the failed attempt is logged into memory. If, however, the product accessibility determination passes, then a measurement verification process is executed, a payment process is executed to obtain payment for the product, and the product is dispensed to the user.

In one embodiment, the user verification process is executed locally. The dispensing system retrieves, from storage on the identification card, biometric data associated with the user identification. The stored biometric data is then compared with the biometric data obtained from the user. If the stored biometric data does not match the biometric data obtained from the user, then the user verification process is indicated to have failed. If, however, the stored biometric data matches the biometric data obtained from the user, then the user verification process is indicated to have passed, and the product accessibility determination is executed to see if the user can purchase the requested product and in what quantity.

In an alternative embodiment, the user verification process is executed remotely over a computer network on a user verification server computer. In this case, the biometric data obtained from the user and the user identification from the identification card are each transmitted to the user verification server computer. The user verification server uses the user identification to retrieve from an associated database stored biometric data associated with the user identification. The user verification server then compares the stored biometric data with the biometric data obtained from the user. If the stored biometric data does not match the biometric data obtained from the user, then the user verification process is indicated to have failed. If, however, the stored biometric data matches the biometric data obtained from the user, then the user verification process is indicated to have passed, and the product accessibility determination is executed to see if the user can purchase the requested product and in what quantity.

In one embodiment, the product accessibility determination is executed locally. The dispensing system accesses a product utilization rule that specifies an allowed utilization of the controlled substance by the user, and accesses from a locally located utilization database a utilization record that indicates a prior utilization of the controlled substance by the user. The dispensing system will then determine, by reference to the accessed product utilization rule, if the user is permitted to obtain from the dispensing system the requested product comprising the controlled substance. If it is determined that the user is not permitted to obtain from the dispensing system the requested product comprising the controlled substance, then the product accessibility determination is indicated to have failed. If, however, it is determined that the user is permitted to obtain from the dispensing system the requested product comprising the controlled substance, then the product accessibility determination is indicated to have passed, and the measurement verification process and payment process are executed, and the product is dispensed to the user.

In a further alternative embodiment, the product accessibility determination is executed remotely over a computer network on a distribution control server computer. In this case, the distribution control server computer accesses a product utilization rule that specifies an allowed utilization of the controlled substance by the user, and it accesses from a utilization database a utilization record that indicates a prior utilization of the controlled substance by the user. The distribution control server computer then determines, by reference to the accessed product utilization rule, if the user is permitted to obtain from the dispensing system the requested product comprising the controlled substance. If it is determined that the user is not permitted to obtain from the dispensing system the requested product comprising the controlled substance, then the product accessibility determination is indicated to have failed. If, however, it is determined that the user is permitted to obtain from the dispensing system the requested product comprising the controlled substance, then the product accessibility determination is indicated to have passed, and the measurement verification process and payment process are executed, and the product is dispensed to the user.

The automated product dispensing system of this invention has a card reader for reading an identification card, a biometric interface for obtaining biometric data from a user, a user input device, a user output device, measurement means for measuring an allowed amount of a product comprising a controlled substance; dispensing means for dispensing the allowed amount of the product comprising a controlled substance; and processing means, coupled to the card reader, the biometric interface, the user input device, the user output device, the measurement means, and the dispensing means. The processing means is programmed to receive a request from a user to obtain from the dispensing system a product comprising a controlled substance; read an identification card presented by the user, the identification card being encoded with a user identification; utilize a biometric data input device to obtain biometric data from the user; and execute a user verification process using the user identification and the biometric data obtained from the user. If the user verification process fails, then the processing means is further programmed to inform the user that access to the product is denied. If, however, if the user verification process passes, then the processing means is further programmed to execute a product accessibility determination. If the product accessibility determination fails, then the processing means is programmed to inform the user that access to the product is denied. If, however, the product accessibility determination passes, then the processing means is further programmed to execute a measurement process to measure an allowed amount of a product and a payment process to obtain payment for the product; and dispense the product to the user.

The biometric interface of the automated product dispensing system may include a retina scanning device, a fingerprint reading device, and/or a voice scanning device.

In one embodiment, the processing means is programmed to execute the user verification process locally by performing the steps of retrieving, from storage on the identification card, biometric data associated with the user identification; and then comparing the stored biometric data with the biometric data obtained from the user. If the stored biometric data does not match the biometric data obtained from the user, then the processing means is further programmed to indicate that the user verification process has failed. If, however, the stored biometric data matches the biometric data obtained from the user, then the processing means is further programmed to indicate that the user verification process has passed, and the product accessibility determination is executed to see if the user can purchase the requested product and in what quantity.

In an alternative embodiment, the dispensing system further includes a user verification server computer remotely accessible over a computer network. In this case, the processing means is programmed to execute the user verification process in conjunction with the user verification server computer by performing the steps of transmitting the biometric data obtained from the user and the user identification from the identification card to the user verification server computer. The user verification server uses the user identification to retrieve from an associated database stored biometric data associated with the user identification; and then compares the stored biometric data with the biometric data obtained from the user. If the stored biometric data does not match the biometric data obtained from the user, then the user verification server computer is programmed to indicate that the user verification process has failed. If, however, the stored biometric data matches the biometric data obtained from the user, then the user verification server computer is programmed to indicate that the user verification process has passed, and the product accessibility determination is executed to see if the user can purchase the requested product and in what quantity.

In one embodiment, the processing means is programmed to execute the product accessibility determination locally by performing the steps of accessing a product utilization rule that specifies an allowed utilization of the controlled substance by the user; accessing from a locally located utilization database a utilization record that indicates a prior utilization of the controlled substance by the user; and then determining, by reference to the accessed product utilization rule, if the user is permitted to obtain from the dispensing system the requested product comprising the controlled substance. If it is determined that the user is not permitted to obtain from the dispensing system the requested product comprising the controlled substance, then the processing means is further programmed to indicate that the product accessibility determination has failed. If, however, it is determined that the user is permitted to obtain from the dispensing system the requested product comprising the controlled substance, then the processing means is further programmed to indicate that the product accessibility determination has passed, and the measurement verification process and payment process are executed, and the product is dispensed to the user.

In an alternative embodiment, the dispensing system further includes a distribution control server computer remotely accessible over a computer network. In this case, the distribution control server computer is programmed to perform the steps of accessing a product utilization rule that specifies an allowed utilization of the controlled substance by the user; accessing from a utilization database a utilization record that indicates a prior utilization of the controlled substance by the user; and then determining, by reference to the accessed product utilization rule, if the user is permitted to obtain from the dispensing system the requested product comprising the controlled substance. If it is determined that the user is not permitted to obtain from the dispensing system the requested product comprising the controlled substance, then the distribution control server computer is further programmed to indicate that the product accessibility determination has failed. If, however, it is determined that the user is permitted to obtain from the dispensing system the requested product comprising the controlled substance, then the distribution control server computer is further programmed to indicate that the product accessibility determination has passed, and the measurement verification process and payment process are executed, and the product is dispensed to the user.

### BRIEF DESCRIPTION OF THE DRAWING

FIG. 1 is a basic block diagram of an embodiment of the invention.

FIG. 2 is a block diagram of an automated dispensing system of an embodiment of the invention.

FIG. 3 is a basic flowchart of the operation of an embodiment of the invention.

FIG. 4 is a flowchart of the user verification process utilized in the flowchart of FIG. 3.

FIG. 5 is a flowchart of the product accessibility determination process utilized in the flowchart of FIG. 3.

### DETAILED DESCRIPTION OF THE PREFERRED EMBODIMENT

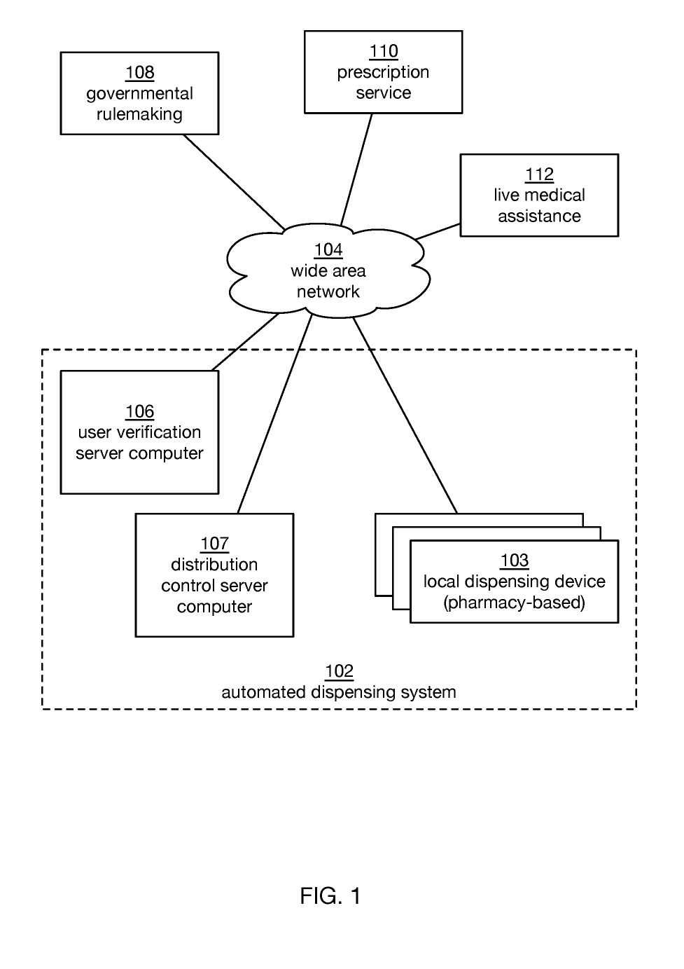

Referring now to the Figures, the embodiments of the invention will be described in detail. FIG. 1 is a basic block diagram of an embodiment of the invention that illustrates the main components and their interaction. The automated dispensing system of the preferred embodiment is adapted via the present invention to be able to dispense products that include a controlled substance. The term automated dispensing system includes a stand-alone unit intended to carry out the functions described herein, and it also includes an automated dispensary that could be located within an existing pharmacy.

Shown in FIG. 1 is an automated dispensing system 102 of the preferred embodiment. The automated dispensing system 102 includes a local, pharmacy-based, automatic dispensing device 103 that has the ability to operate in a stand-alone mode if desired. The automated dispensing system 102 may also include a remotely located user verification server computer 106 and a distribution control server computer 107, each of which are interconnected to the local dispensing device 103 via the network 104 such as the internet. More than one local dispensing device 103 is contemplated by this invention, each of which would be similarly connected to the user verification server computer 106 and the distribution control server computer 107 via the network 104 as well known in the art. By using a centralized model implementing remotely located servers 106 and 107, a user could obtain products having a controlled substance from any of the local dispensing devices 103, regardless of their location, since the user verification and product distribution controls are centrally located and accessible to all such local dispensing devices 103 via the network 104. In the alternative, all the functions required by the automated dispensing system may be carried out by the local dispensing device 103 operating without the remote servers 106, 107, as will be explained in detail below. In addition, the functionality provided by the servers 106, 107 may be combined into one single physical computer if desired.

Also shown in FIG. 1 is a governmental rulemaking module 108, which represents one or more server computers having intelligence and logic stored thereon that reflect the rules of one or more jurisdictions within which the dispensing devices 103 are located. For example, if a local dispensing device 103 is located in New York City, then the governmental rulemaking module 108 would provide the product distribution and consumption rules (e.g. laws) for New York City, N.Y. State, as well as the federal government of the United States. Similarly, if a local dispensing device 103 is located in Los Angeles, then the governmental rulemaking module 108 would provide the product distribution and consumption rules (e.g. laws) for Los Angeles, Calif., as well as the federal government of the United States. Further subdivisions of the governmental jurisdictions may be implemented (e.g. on a county level, etc.). Thus, the governmental rulemaking module 108 is consulted with by the dispensing system 108 whenever a product purchase has been requested that contains a controlled substance.

Similarly, a prescription service module 110 represents one or more server computers having intelligence and logic stored thereon that reflect a prescription that a user may have obtained from a doctor that enables the user to obtain the controlled substance. For example, a user may have a prescription that allows him to obtain 500 mg of a prescription pain killer each week for up to 8 weeks. That prescription information will be stored at the prescription service 110 and consulted with by the dispensing system 102 whenever a product purchase has been requested for that pain killer.

FIG. 1 also shows a live medical assistance module 112, which provides users of the system with a direct chat line to obtain advice and possibly prescriptions from live medical personnel. For example, a doctor may be available to consult with the user regarding a pain medication, and get the prescription changed if necessary.

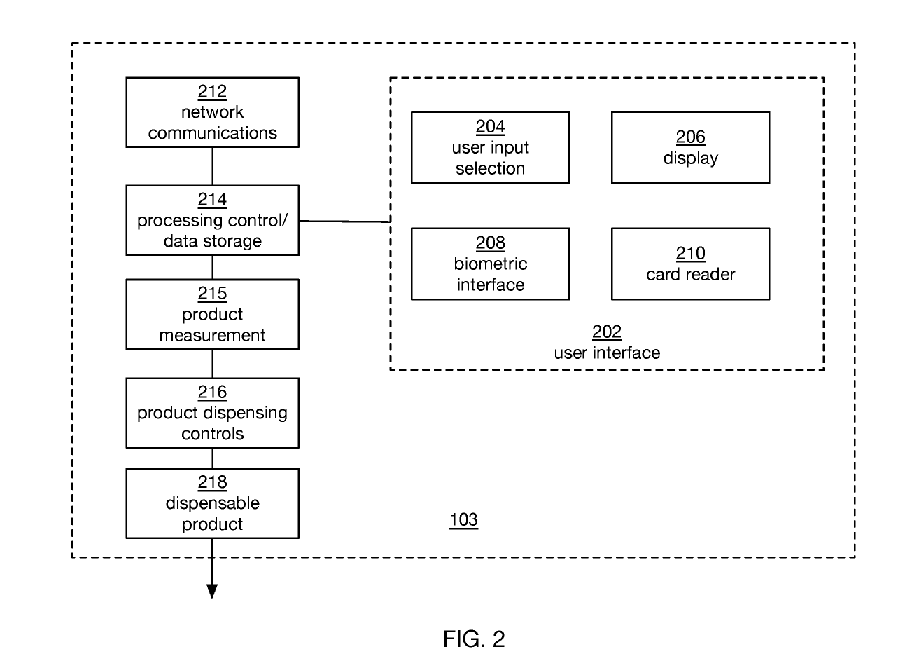

FIG. 2 is a block diagram of a local dispensing device 103 of an embodiment of the invention. In this embodiment, the dispensing device 103 has a user interface 202 for interacting with a user that requests the product including the controlled substance. The user interface 202 includes a user input selection module 204, which may be any type of input device known in the art such as a keypad, touchscreen, microphone, and the like. This allows the user to make the request and provide additional inputs as may be requested. Display 206 is provided to display information to the user in visual form (and may include a speaker for spoken feedback). The display 206 and user input device 204 may be integrated in the same unit, such as a touchscreen, if desired.

Card reader 210 is provided for reading an identification card presented by the user. This may be any type of card reader as known in the art, such as a magnetic stripe reader, proximity sensor, RFID reader, bar code scanner, etc. The identification card is provided to each user of the system to enable him to gain access to the dispensing device 103 in a secure manner as will be described. Biometric interface 208 is also provided in the user interface 202, and it used for obtaining biometric data from a user in order to ensure the user's identity. Any one or more of the following biometric techniques may be implemented here as known in the art; e.g. a retina scan, fingerprint scan, or a vocal scan.

Other components in the dispensing device 103 include a product measurement means 215 for measuring an allowed amount of a product comprising a controlled substance. Typically, this would be a scale that the product is placed upon as part of the dispensing process. As will be described further herein, the measurement means may be used to ensure that a prepackaged amount of the requested controlled substance is correct, or at least within tolerance. For example, the user may be allowed only to obtain 500 mg of a prescription pain killer each week. The measurement means may be used by the dispensing system to ensure that only 500 mg is provided (e.g. there are no errors in packaging). The dispensing device 103 also has dispensing means for dispensing the product comprising a controlled substance, shown as product dispensing controls 216. Various types of dispensing system dispensing means exist in the prior aft and may be used herein. For example, a robotic arm may be used to select the requested product from a secure storage area in the dispensing device 103 and place the selected product into an area accessible by the user.

Processing control and data storage 214 are coupled to the card reader 210, the biometric interface 208, the user input device 204, the user output device 206, the measurement means 215, and the dispensing means 216. The processing means 214 is programmed to perform the various functions of the dispensing device 103, including receiving a request input from a user via the input means 204 to obtain from the dispensing system 102 a product 218 including a controlled substance, receiving an identification card presented by the user via the card reader 210; utilizing the biometric data input device 208 to obtain biometric data from the user; and executing a user verification process using the user identification and the biometric data obtained from the user, all of which are described in further detail below. A network communications device 212 is used by the dispensing device 103 to communicate over the network 104 as well known in the art, for example with the user verification server computer 106 and/or the distribution control server computer 107.

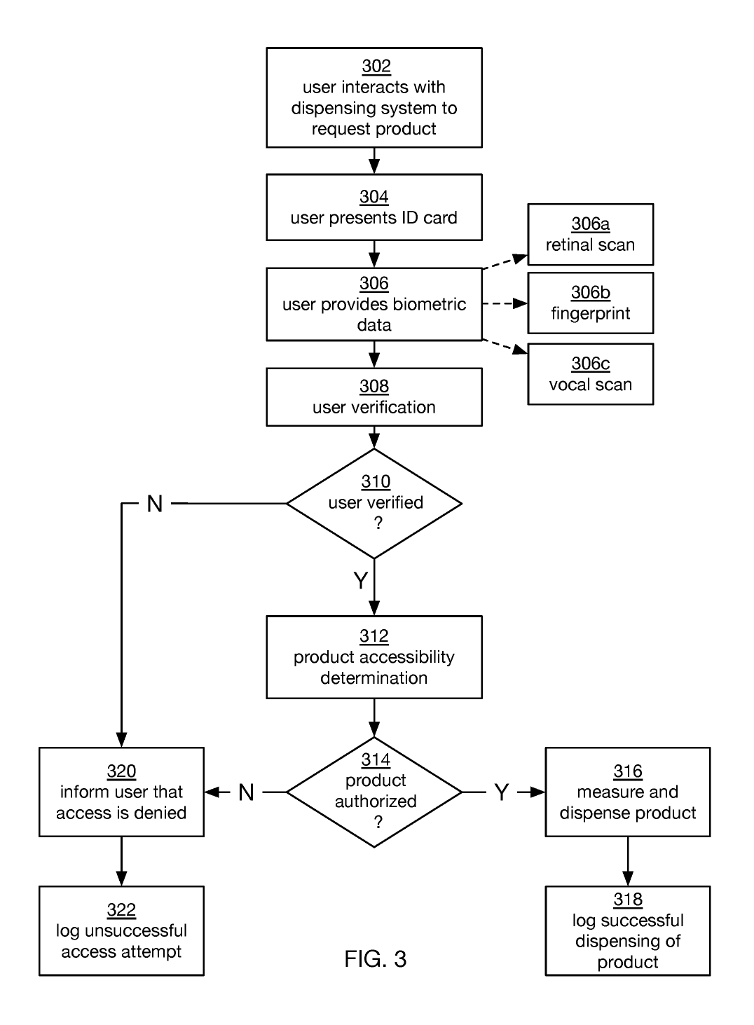

FIG. 3 is a basic flowchart of the operation of an embodiment of the invention for dispensing a product that has a controlled substance. In this embodiment, the user at step 302 interacts with the dispensing device 103 to request the desired product that includes a controlled substance. At step 304 the user presents an identification card to the card reader 210, the identification card being encoded with a user identification. The user identification may be encoded using a magnetic stripe, a chip mounted on the card (a smart card), and the like. The identification may be the user's name, address, social security number, patient number, etc. At step 306 the user provides biometric data to the biometric interface 208, which may include retinal scan data 306a, fingerprint data 306b, and/or vocal scan data 306c. At step 308, a user verification process is executed using the user identification read from the ID card and the biometric data obtained from the user. At step 310, if the user verification process fails, then the user is informed at step 320 that access to the product is denied and the unsuccessful access attempt is logged at step 322 into memory. If, however, the user verification process passes, then at step 312 a product accessibility determination is executed. If the product accessibility determination fails at step 314, then the user is informed at step 320 that access to the product is denied and the unsuccessful access attempt is logged at step 322 into memory. If, however, the product accessibility determination passes at step 314, then a product measurement and dispensing process 316 is executed (which includes a payment process) and the successful dispensing of the product is logged at step 318 into memory.

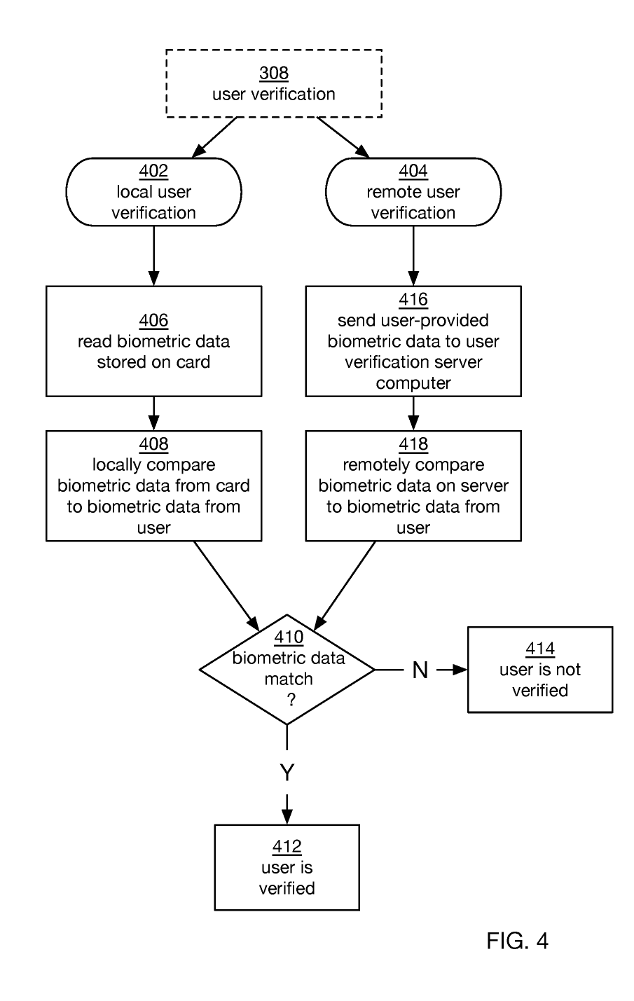

FIG. 4 is a detailed flowchart of the user verification process 308 utilized in the flowchart of FIG. 3. The user verification process 308 may be executed locally on the local dispensing device 103 at step 402, or it may be executed remotely at step 404 on the user verification server computer 106 that interoperates with a plurality of dispensing devices 103 over the computer network. In the embodiment that implements the local user verification process at step 402, the processing circuitry 214 will read biometric data associated with the user identification that is stored on a memory chip on the user ID card at step 406. The stored biometric data from the card will be compared locally at step 408 by the local dispensing device 103 to the biometric data that has just been obtained from the user. If at step 410 the stored biometric data does not match the biometric data obtained from the user, then the user is flagged as an unverified user at step 414, and the user is informed that the product will not be dispensed by the dispensing system. If, however, at step 410 the stored biometric data matches the biometric data obtained from the user, then the user is flagged as a verified user at step 412.

The remote user verification process at step 404 is similar, but is carried out by the user verification server computer 106 rather than locally at the dispensing device 103. In this case, the user's biometric data is stored at the server 106 rather than on the ID card. It may be desired to store the data on the server 106 since the user will not have to be concerned with the ID card being stolen and the biometric data obtained from the card by the thief. On the other hand, it may be advantageous to store the data on the ID card rather than at the server 106 so that the biometric data is always under the user's control, rather than being accessible by the service that implements the server 106, which may provide better privacy for the user. Either process will operate effectively in this invention and the specific implementation may be left up to the system designer.

In particular, the remote user verification process 404 operates as follows. The local dispensing device 103 transmits at step 416 the biometric data obtained from the user and the user identification from the identification card to the user verification server computer 106. At step 418, the user verification server computer 106 uses the user identification to retrieve from an associated database the stored biometric data associated with the user identification and compares the stored biometric data with the biometric data obtained from the user. If at step 410 the stored biometric data does not match the biometric data obtained from the user, then the user is flagged as an unverified user at step 414, that flag is sent back to the local dispensing device 103, and the user is informed that the product will not be dispensed by the dispensing system. If, however, at step 410 the stored biometric data matches the biometric data obtained from the user, then the user is flagged as a verified user at step 412, and that flag is sent back to the local dispensing device 103.

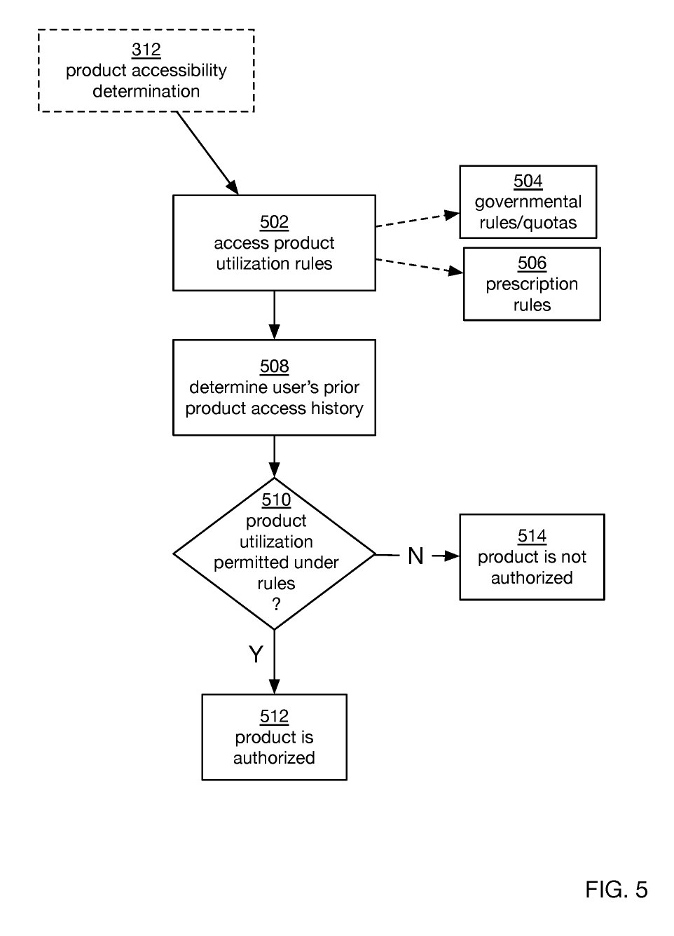

FIG. 5 is a detailed flowchart of the product accessibility determination process 312 utilized in the flowchart of FIG. 3, which may be executed locally at the local dispensing device 103 or by reference to the distribution control server computer 107, which is preferred in a system that has multiple local devices 103. In either case, the process operates in a similar manner. The product accessibility determination process 312 is executed by accessing at step 502 a product utilization rule(s) that specifies an allowed utilization of the controlled substance by the user. This may include accessing at step 504 a set of governmental rules and/or quotas by reference to an external database such as the governmental rulemaking module 108, which represents one or more server computers having intelligence and logic stored thereon that reflect the rules of one or more jurisdictions within which the dispensing systems 102 are located. For example, the state in which the user resides may impose a rule that allows only 4 ounces of marijuana to be sold to any single user in a one week period. In the alternative or in addition, step 506 provides access to a set of prescription rules, such as in the prescription service module 110 that represents one or more server computers having intelligence and logic stored thereon that reflect a prescription that a user may have obtained from a doctor that enables the user to obtain the controlled substance. For example, a user may have a prescription that allows him to obtain 500 mg of a prescription pain killer each week for up to 8 weeks. That prescription information will be stored at the prescription service 110 and consulted with by the dispensing system 102 at step 506 whenever a product purchase has been requested for that pain killer.

Once the rules for product utilization have been accessed, which may apply to the population generally and/or the individual user, then at step 508 the user's prior product access history is accessed. That is, a utilization database is accessed to obtain a utilization record(s) that indicates a prior utilization of the controlled substance by the user. This utilization database may reside online, for example at the distribution control server computer 107, which is accessed via the network 104. In the alternative, the utilization records may be stored in the user ID card (smart card chip storage) or locally at the local dispensing device 103. Next, at step 510, it is determined, by reference to the accessed product utilization rule(s), if the user is permitted to obtain from the dispensing system the requested product comprising the controlled substance, based on the rules and that user's prior utilization history. If it is determined at step 510 that the user is permitted to obtain from the dispensing system the requested product that has the controlled substance, then the product is flagged as an authorized product at step 512. If, however, it is determined that the user is not permitted to obtain from the dispensing system the requested product comprising the controlled substance, then the product is flagged at step 514 as an unauthorized product and the user is informed that the product will not be dispensed by the dispensing system.

If the product is flagged as an authorized product, then a measurement process is executed at step 316 at the local dispensing device 103 by which an allowed quantity of the product is measured for dispensing to the user. A payment process is executed to obtain payment for the product (such as a credit card payment process). The product is then dispensed to the user, and the utilization record is updated in the utilization database to indicate that the user has obtained the measured quantity of the product that has the controlled substance.

In an alternative embodiment, a live physician may be present, either in person or virtually, to assist on the approval process. For example, some jurisdictions may require that a physician be part of the approval process. In this case, the automated dispensing system would provide a chat window on the display, similar to the well-known help chat windows used in online commerce situations. This could provide assistance in the medication approval process, as well as advising users with respect to their requests. The live/virtual physician may be able to override the automated decision-making process described above for various reasons, such as emergency or error in the system. By centralizing the physician availability and making him or her available to many users in a near simultaneous fashion, costs are greatly reduced and quality of service is increased.

What is claimed is:

1. A method for dispensing a product comprising a controlled substance comprising
a dispensing system receiving a request from a user to obtain from the dispensing system a product comprising a controlled substance;
the dispensing system reading an identification card presented by the user, the identification card being encoded with a user identification;
the dispensing system utilizing a biometric data input device to obtain biometric data from the user;
the dispensing system executing a user verification process using the user identification and the biometric data obtained from the user;
if the user verification process fails, then informing the user that access to the product is denied; and
if the user verification process passes, then
executing a product accessibility determination;
if the product accessibility determination fails, then informing the user that access to the product is denied, and
if the product accessibility determination passes, then
measuring an allowed amount of the product;
executing a payment process to obtain payment for the product; and
dispensing the product to the user.

2. The method of claim 1 wherein the biometric data comprises retinal scan data.

3. The method of claim 1 wherein the biometric data comprises fingerprint data.

4. The method of claim 1 wherein the biometric data comprises vocal scan data.

5. The method of claim 1 wherein the user verification process is executed locally by the steps of
retrieving, from storage on the identification card, biometric data associated with the user identification;
comparing the stored biometric data with the biometric data obtained from the user;
if the stored biometric data does not match the biometric data obtained from the user, then indicating that the user verification process has failed; and
if the stored biometric data matches the biometric data obtained from the user, then indicating that the user verification process has passed.

6. The method of claim 1 wherein the user verification process is executed remotely over a computer network on a user verification server computer by the steps of
transmitting the biometric data obtained from the user and the user identification from the identification card to the user verification server computer;
the user verification server using the user identification to retrieve from an associated database stored biometric data associated with the user identification; and
the user verification server comparing the stored biometric data with the biometric data obtained from the user;
if the stored biometric data does not match the biometric data obtained from the user, then indicating that the user verification process has failed; and
if the stored biometric data matches the biometric data obtained from the user, then indicating that the user verification process has passed.

7. The method of claim 1 wherein the product accessibility determination is executed locally by the steps of
accessing a product utilization rule that specifies an allowed utilization of the controlled substance by the user;
accessing from a locally located utilization database a utilization record that indicates a prior utilization of the controlled substance by the user;
determining, by reference to the accessed product utilization rule, if the user is permitted to obtain from the dispensing system the requested product comprising the controlled substance;
if it is determined that the user is not permitted to obtain from the dispensing system the requested product comprising the controlled substance, then indicating that the product accessibility determination has failed, and
if it is determined that the user is permitted to obtain from the dispensing system the requested product comprising the controlled substance, then indicating that the product accessibility determination has passed.

8. The method of claim 1 wherein the product accessibility determination is executed remotely over a computer network on a distribution control server computer by the steps of
a distribution control server computer accessing a product utilization rule that specifies an allowed utilization of the controlled substance by the user;
the distribution control server computer accessing from a utilization database a utilization record that indicates a prior utilization of the controlled substance by the user;
the distribution control server computer determining, by reference to the accessed product utilization rule, if the user is permitted to obtain from the dispensing system the requested product comprising the controlled substance;
if it is determined that the user is not permitted to obtain from the dispensing system the requested product comprising the controlled substance, then the distribution control server computer indicating that the product accessibility determination has failed, and
if it is determined that the user is permitted to obtain from the dispensing system the requested product comprising the controlled substance, then the distribution control server computer indicating that the product accessibility determination has passed.

9. An automated product dispensing system comprising
a card reader for reading an identification card,
a biometric interface for obtaining biometric data from a user, a user input device,
a user output device,
measurement means for measuring an allowed amount of a product comprising a controlled substance;
dispensing means for dispensing the allowed amount of the product comprising a controlled substance; and
processing means, coupled to the card reader, the biometric interface, the user input device, the user output device, the measurement means, and the dispensing means, said processing means being programmed to
receive a request from a user to obtain from the dispensing system a product comprising a controlled substance;
read an identification card presented by the user, the identification card being encoded with a user identification;
utilize a biometric data input device to obtain biometric data from the user;
execute a user verification process using the user identification and the biometric data obtained from the user;
if the user verification process fails, then inform the user that access to the product is denied; and
if the user verification process passes, then
execute a product accessibility determination;
if the product accessibility determination fails, then inform the user that access to the product is denied, and
if the product accessibility determination passes, then execute a measurement process to measure an allowed amount of a product and a payment process to obtain payment for the product; and
dispense the product to the user.

10. The dispensing system of claim 9 wherein the biometric interface comprises a retina scanning device.

11. The dispensing system of claim 9 wherein the biometric interface comprises a fingerprint reading device.

12. The dispensing system of claim 9 wherein the biometric interface comprises a voice scanning device.

13. The dispensing system of claim 9 wherein the processing means is programmed to execute the user verification process locally by performing the steps of
retrieving, from storage on the identification card, biometric data associated with the user identification;
comparing the stored biometric data with the biometric data obtained from the user;
if the stored biometric data does not match the biometric data obtained from the user, then indicating that the user verification process has failed; and
if the stored biometric data matches the biometric data obtained from the user, then indicating that the user verification process has passed.

14. The dispensing system of claim 9 further comprising a user verification server computer remotely accessible over a computer network, and wherein the processing means is programmed to execute the user verification process in conjunction with the user verification server computer by performing the steps of
transmitting the biometric data obtained from the user and the user identification from the identification card to the user verification server computer;
the user verification server using the user identification to retrieve from an associated database stored biometric data associated with the user identification; and
the user verification server comparing the stored biometric data with the biometric data obtained from the user;
if the stored biometric data does not match the biometric data obtained from the user, then indicating that the user verification process has failed; and
if the stored biometric data matches the biometric data obtained from the user, then indicating that the user verification process has passed.

15. The dispensing system of claim 9 wherein the processing means is programmed to execute the product accessibility determination locally by performing the steps of
accessing a product utilization rule that specifies an allowed utilization of the controlled substance by the user;
accessing from a locally located utilization database a utilization record that indicates a prior utilization of the controlled substance by the user;
determining, by reference to the accessed product utilization rule, if the user is permitted to obtain from the dispensing system the requested product comprising the controlled substance;
if it is determined that the user is not permitted to obtain from the dispensing system the requested product comprising the controlled substance, then indicating that the product accessibility determination has failed, and
if it is determined that the user is permitted to obtain from the dispensing system the requested product comprising the controlled substance, then indicating that the product accessibility determination has passed.

16. The dispensing system of claim 9 further comprising a distribution control server computer remotely accessible over a computer network, and wherein the distribution control server computer is programmed to perform the steps of
accessing a product utilization rule that specifies an allowed utilization of the controlled substance by the user;
accessing from a utilization database a utilization record that indicates a prior utilization of the controlled substance by the user;
determining, by reference to the accessed product utilization rule, if the user is permitted to obtain from the dispensing system the requested product comprising the controlled substance;
if it is determined that the user is not permitted to obtain from the dispensing system the requested product comprising the controlled substance, then indicating that the product accessibility determination has failed, and
if it is determined that the user is permitted to obtain from the dispensing system the requested product comprising the controlled substance, then indicating that the product accessibility determination has passed.
